(19) United States
(12) Patent Application Publication
(10) Pub. No.: US 2026/0004228 A1
(43) Pub. Date: Jan. 1, 2026

(54) Renumero

(71) Applicants: Henry Hooman Griffith, Colts Neck, NJ (US); Sean James Griffith, Colts Neck, NJ (US)

(72) Inventors: Henry Hooman Griffith, Colts Neck, NJ (US); Sean James Griffith, Colts Neck, NJ (US)

(21) Appl. No.: 19/249,056

(22) Filed: Jun. 25, 2025

Related U.S. Application Data
(60) Provisional application No. 63/664,731, filed on Jun. 27, 2024.

(51) Int. Cl. G06Q 10/0834; G06Q 10/0833; G06Q 50/43

(52) U.S. Cl. CPC G06Q 10/0834; G06Q 10/0833; G06Q 50/43

(57) ABSTRACT

Renumero will be a charity/company that delivers necessary care packages to the homeless people of the world with the touch of a button on an app (which has yet to be developed). It will allow meals and care packages to be delivered to a precise, specified location such as a street corner or alleyway.

### OVERVIEW

### Abstract

Renumero will be a charity/company that delivers necessary care packages to the homeless people of the world with the touch of a button on an app (which has yet to be developed). It will allow meals and care packages to be delivered to a precise, specified location such as a street corner or alleyway.

### Addressing the Problem

Renumero will address homeless people's needs in a technologically advanced fashion through a mobile app. Using an app, the buyer will be able to select from different types of care packages to give to the homeless person, pinpoint that person's location, and have a delivery driver drop the package off at that spot within minutes.

### Step by Step

Renumero connects three people—the donor, the driver, and the recipient—by means of a mobile app. Here is how it works:
1. First, an ordinary person (donor) going about his or her daily life notices a homeless person or other person in need (recipient).
2. The donor takes out their phone and brings up the Renumero app.
3. The Renumero app provides the donor with a variety of pre-made care packages from which to choose. The donor selects a package and pinpoints (via GPS coordinates on a street map) the location of the recipient.
4. The Renumero app transmits the information to nearby Renumero drivers who are rideshare contractors that have agreed to carry and deliver Renumero packages. The drivers will carry Renumero packages with them for delivery.
5. The nearest Renumero driver accepts the request and delivers the package to the recipient at the requested location.

1. A system for facilitating targeted delivery of care packages to persons in need, the system comprising:
a mobile application configured to be executed on a user device, the mobile application comprising:
a graphical user interface configured to present a plurality of predefined care package options for user selection; and
a location identification module configured to receive a geolocation input from the user specifying a delivery location;
a remote server in communication with the mobile application, the remote server configured to:
receive data corresponding to the selected care package and the specified delivery location; and
transmit the received data to a network of delivery drivers;
a plurality of delivery drivers equipped with mobile devices configured to receive delivery requests from the remote server; and
a routing and assignment engine configured to:
identify an available delivery driver based on proximity to the specified delivery location and package availability; and
assign the delivery request to the identified delivery driver;
wherein the assigned delivery driver is configured to transport the selected care package to the delivery location provided by the geolocation input.

2. The system of claim 1, wherein each care package comprises one or more of: food, hygiene items, clothing, or weather-appropriate supplies.

3. The system of claim 1, wherein the location identification module is configured to display a GPS-enabled map interface for user interaction.

4. The system of claim 1, wherein the mobile application is further configured to provide real-time delivery status updates to the user.

5. The system of claim 1, wherein the delivery drivers are independent contractors who carry pre-stocked care packages in their vehicles.

6. The system of claim 1, further comprising a payment module integrated into the mobile application, the payment module configured to facilitate in-app donations or purchases of care packages.

7. The system of claim 1, wherein the routing and assignment engine utilizes a priority algorithm based on driver proximity, delivery urgency, and package inventory.
